(19) United States
(12) Patent Application Publication
(10) Pub. No.: US 2015/0256904 A1
(43) Pub. Date: Sep. 10, 2015

(54) APPARATUS AND METHOD FOR PLAYING MEDIA

(71) Applicants: Yoon CHI, Gwacheon-si (KR); Ji-Young KIM, Gwacheon-si (KR)

(72) Inventors: Yoon CHI, Gwacheon-si (KR); Ji-Young KIM, Gwacheon-si (KR)

(21) Appl. No.: 14/638,921

(22) Filed: Mar. 4, 2015

(30) Foreign Application Priority Data
Mar. 5, 2014 (KR) 10-2014-0026280

(51) Int. Cl. H04N 21/81; H04N 21/4725; H04N 21/435; H04N 21/858

(52) U.S. Cl. CPC H04N 21/8133; H04N 21/858; H04N 21/4725; H04N 21/435

(57) ABSTRACT

A method for playing media according to an embodiment of the present invention comprises playing media information of the media file; extracting link information from the media file; displaying a link according to a start time and a duration time of the link information; receiving a user input for selecting a link; and receiving contents corresponding to the link selected by the user.

### CROSS REFERENCE TO RELATED APPLICATION

This application claims the benefit of Korean Patent Application No. 10-2014-0026280, filed on Mar. 5, 2014, entitled “Apparatus and method for playing media”, which is hereby incorporated by reference in its entirety into this application.

### BACKGROUND OF THE INVENTION

1. Technical Field

The present invention relates to a technology for playing media and more particularly, to a technology for playing medial files including time-based link information.

2. Description of the Related Art

As communication technology develops, playing medial files such as video by receiving them through a network becomes a common technique.

In addition, those medial files such as video can be more easily accepted to users, compared to information in text formats.

However, since general media files do not provide information about people, goods(things), places and the like dealt in media, users must obtain the information through separate searches.

For example, when a particular product is shown in a media file and a user wants to know about the product, the user may have difficulty to search for the product since the use does not know the name of the product. Even though the user knows the name of the product, it may cause an inconvenience since a separate search must be performed by using an available device.

### SUMMARY OF THE INVENTION

An object of the invention is to provide an apparatus for playing media which plays media files including link information to which a user can easily access.

According to an aspect of the present invention, there is provided an apparatus for playing media comprising a communication interface receiving a medial file through a network by being connected with a media file providing apparatus; a processor playing the media file according to a predetermined program; and a memory storing the program, wherein the program is a program to perform: playing media information of the media file; extracting link information from the media file; displaying a link according to a start time and a duration time of the link information; receiving a user input for selecting a link; and receiving contents corresponding to the link selected by the user.

The start time may be the time when the link starts to be displayed, and the duration time may be the time during the link is displayed.

The step for displaying a link according to a start time and a duration time of the link information may comprise displaying the link with an icon corresponding to icon identification information included in the link information.

The step for displaying a link according to a start time and a duration time of the link information may comprise displaying the icon at the location corresponding to location information of the link information.

The program may be a program further to perform outputting the contents according to output modes included in the link information.

The output mode may be any one of sound, picture in picture (PIP), main screen output, and download.

The program may be a program further to perform stopping playing media information according to play stop information of the link information.

The program may be a program further to perform resuming playing media information according to play resume information of the link information.

The program may be a program further to perform displaying the link corresponding to a plurality of link information included in group link information when the link information is group link information and a user input for selecting an icon corresponding to the group link information is received.

The link information may be located right after a header or a key frame of the media file.

According to another aspect of the present invention, there is provided a method for playing media when an apparatus for playing media plays a media file, comprising: playing media information of the media file; extracting link information from the media file; displaying a link according to a start time and a duration time of the link information; receiving a user input for selecting a link; and receiving contents corresponding to the link selected by the user.

The start time may be the time when the link starts to be displayed, and the duration time may be the time during the link may be displayed.

The step for displaying a link according to a start time and a duration time of the link information may comprise displaying the link with an icon corresponding to icon identification information included in the link information.

The step for displaying a link according to a start time and a duration time of the link information may comprise displaying the icon at the location corresponding to location information of the link information.

The method for playing media may further comprise outputting the contents according to output modes included in the link information.

The output mode may be any one chosen from sound, picture in picture (PIP), main screen output, and download.

The method for playing media may further comprise stopping playing the media information according to play stop information of the link information.

The method for playing media may further comprise resuming playing the media information according to play resume information of the link information.

The method for playing media may further comprise displaying the link corresponding to a plurality of link information included in group link information when the link information may be group link information and a user input for selecting an icon corresponding to the group link information may be received.

The link information may be located right after a header or a key frame of the media file.

According to an embodiment of the present invention, it allows a user easily to obtain contents for link information during playing a media file.

### BRIEF DESCRIPTION OF DRAWINGS

FIG. 1 is a system for playing media according to an embodiment of the present invention.

FIG. 2 is a block view illustrating an apparatus for playing media according to an embodiment of the present invention.

FIG. 3 is a flowchart illustrating a process for playing media file by an apparatus for playing media according to an embodiment of the present invention.

FIG. 4 is structure of playing media file by an apparatus for playing media according to an embodiment of the present invention.

FIG. 5 is an example illustrating that an apparatus for playing media according to an embodiment of the present invention displays a link.

FIG. 6 is another example illustrating that an apparatus for playing media according to an embodiment of the present invention displays a link.

FIG. 7 is further another example illustrating that an apparatus for playing media according to an embodiment of the present invention displays a link.

FIG. 8 is an example of displaying contents played by an apparatus for playing media according to an embodiment of the present invention.

### DESCRIPTION OF THE EXEMPLARY EMBODIMENTS

While the present invention has been described with reference to particular embodiments, it is to be appreciated that various changes and modifications may be made by those skilled in the art without departing from the spirit and scope of the present invention, as defined by the appended claims and their equivalents.

In addition, throughout the description of the present invention, when it is described as that one element “transmit(s)” a signal to another element, it shall be construed as being “transmitted” from the one element to the another element directly but also as possibly having another element in between.

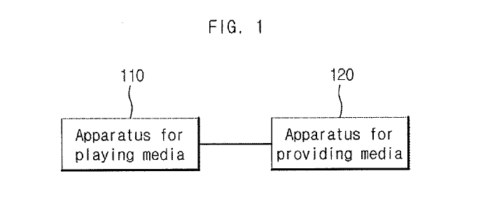

FIG. 1 is a system for playing media according to an embodiment of the present invention.

Referring to FIG. 1, a system for playing media includes an apparatus for playing media 110 and an apparatus for providing media 120.

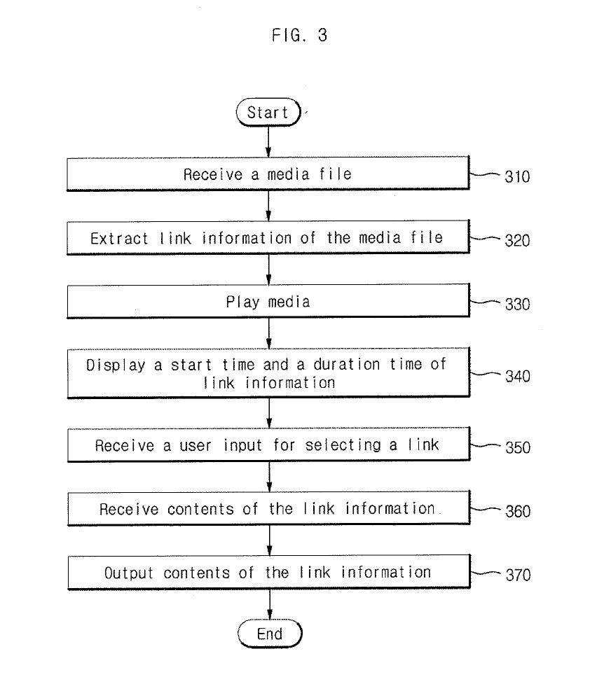

The apparatus for playing media 110 receives a media file from the apparatus for providing media 120 and plays the media file. Here, the media file may be a file such as video, sound and the like encoded by a predetermined coding method. The apparatus for playing media 110 may also receive and play contents by referring to link information included in the media file. Here, the link information includes address information, link type to receive contents through corresponding address information, start time when the link starts to be displayed and duration time during the link is displayed, and the like. Here, the link, which is displayed on the screen, is a user interface triggering reception of the contents selected by a user. It will be described in more detail later by referring to FIG. 3 which illustrates a flowchart of a process for playing media file by an apparatus for playing media according to an embodiment of the present invention.

The apparatus for providing media 120 transmits a medial file to the apparatus for providing media 120 through a network. In addition, the apparatus for providing media 120 receives link information and media information (for example, header encoded by a known method, key frame, video composed of common frames) inputted by a provider and generates a media file by inserting link information right after a header or a key frame of the corresponding media information.

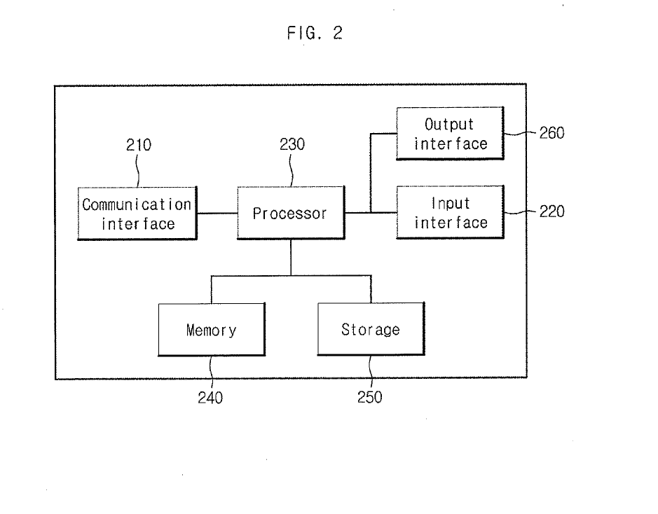

FIG. 2 is a block view illustrating an apparatus for playing media according to an embodiment of the present invention.

Referring to FIG. 2, the apparatus for playing media 110 includes a communication interface 210, an input interface 220, a processor 230, a memory 240, a storage 250 and an output interface 260.

The communication interface 210 receives a medial file from the apparatus for providing media 120 by being connected to the apparatus for providing media 120 through a network.

The input interface 220 receives a user input of a displayed link from an input device such as a touch pad, a mouse and the like.

The processor 230 plays a media file according to instructions stored in the memory 240 and receives contents according to a user link input through the communication interface 210 during the media file is displayed.

The memory 240 stores instructions to play a media file and receive contents. Here, such instructions can be stored in the storage 250 and the processor 230 can load the instructions in the memory 240. The memory 240 may be volatile memory such as random access memory (RAM).

The storage 250 stores instructions. The storage 250 also stores media files and contents received through the communication interface 210.

The output interface 260 outputs video of the media file to a display device such as a monitor and the like. The output interface 260 also outputs sound signals of the media file to a sound output device such as a speaker and the like.

A process for playing a media file by the apparatus for playing media described above will be explained. The apparatus for playing media 110 is called for an object of each step or each process that the processor 230 of the apparatus for playing media 110 performs for a concise and clear description.

FIG. 3 is a flowchart illustrating a process for playing media file by an apparatus for playing media according to an embodiment of the present invention.

Referring to FIG. 3, in Step 310, the apparatus for playing media 110 receives a media file from the apparatus for providing media 120 through the communication interface 210.

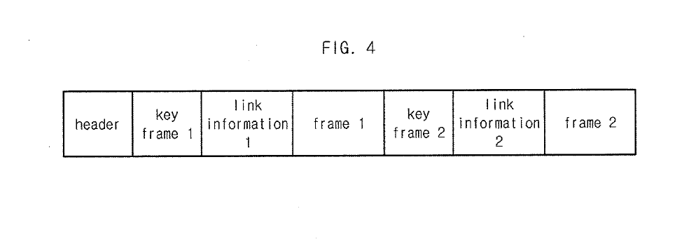

In Step 320, the apparatus for playing media 110 extracts link information from the media file. Description relating to link information of the medial file will be described by referring to FIG. 4 below.

In Step 330, the apparatus for playing media 110 plays media information included in the media file. Here, the apparatus for playing media 110 generates video by decoding the media information by a decoding method predetermined in the media compression standard such as MPEG, DIVX and the like, and displays the generated video through the output interface 260.

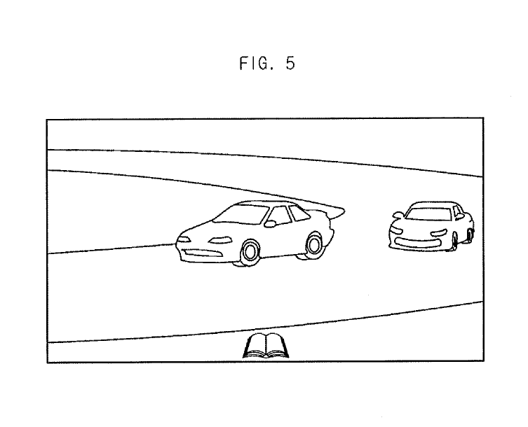

In Step 340, the apparatus for playing media 110 displays a link according to a start time and a duration time of the link information. Here, the start time is the time when the link starts to be displayed, and can be represented by an elapsed time from the time when playing the media file starts. For example, when the start time is 10 sec, the apparatus for playing media 110 can display a link at the elapsed time of 10 seconds from the time when playing a media file starts. Here, the apparatus for playing media 110 can display the link through a predetermined user interface such as icon and the like. Displaying the link will be explained in detail by referring to FIG. 5 to FIG. 7 below.

In Step 350, the apparatus for playing media 110 receives a user input of link through the input interface 220.

In Step 360, the apparatus for playing media 110 receives contents according to link information. For example, when an address of link information is an address of video, the apparatus for playing media 110 can receive the corresponding video.

In Step 370, the apparatus for playing media 110 outputs the contents received in Step 360 through the output interface 260. For example, when the contents received in Step 360 is video, the apparatus for playing media 110 displays the corresponding video through the output interface 260.

FIG. 4 is structure of playing media file by an apparatus for playing media according to an embodiment of the present invention.

Referring to FIG. 4, the media file includes a header, one or more key frames, link information and frames. Here, the link information can be located between the key frame and the frame (right after the key frame). For example, link information 1 is located between a key frame 1 and a frame 1 and link information 2 is located between a key frame 2 and a frame 2 in FIG. 4. Thus, the apparatus for playing media 110 extracts the link information after the key frame of the media file which is being streamed and outputs the link. In addition, link information can include a header depending on an implementation method.

Therefore, the apparatus for playing media 110 can extract and output link information even though the media file is received and played in a streaming format, not receiving and playing the entire media file.

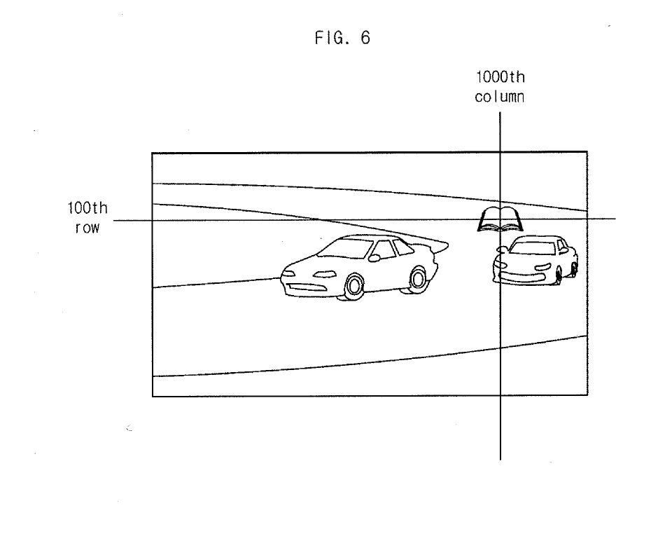

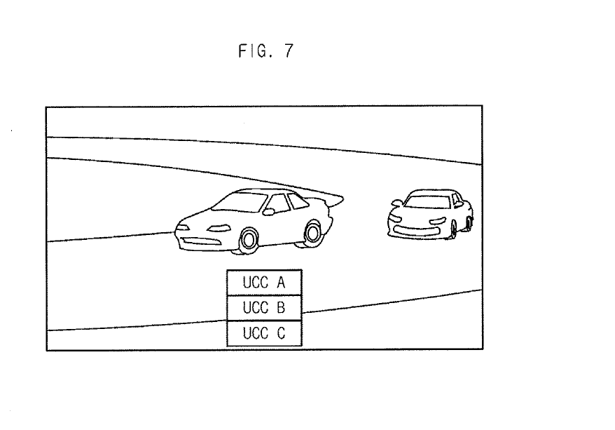

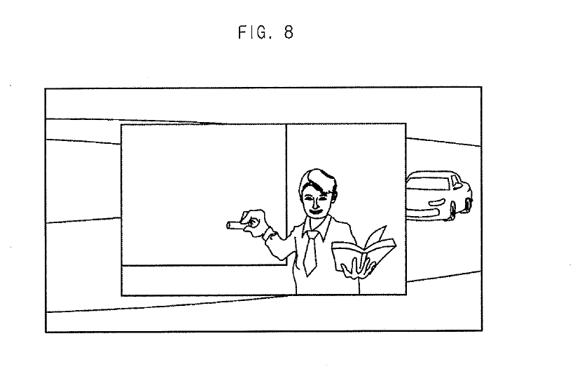

FIG. 5 is a first example illustrating that an apparatus for playing media according to an embodiment of the present invention displays a link, FIG. 6 is a second example illustrating that an apparatus for playing media according to an embodiment of the present invention displays a link, FIG. 7 is a third example illustrating that an apparatus for playing media according to an embodiment of the present invention displays a link, and FIG. 8 is an example of displaying contents played by an apparatus for playing media according to an embodiment of the present invention.

Link information may include at least one of script instructions, start time, duration time, output type, play stop information, icon identification information, and play resume information, etc. Here, the script instruction is an instruction directing which contents corresponding link information receives. The output type is information how outputs the received contents and may be information determined as one of sound, picture in picture (PIP), main screen output, and download. Examples of the output types will be explained below with reference to the accompanying drawings. The play stop information is information indicating whether playing media information of a media file stops or maintains when contents is outputted. The icon identification information is identification information of an icon to be displayed to a link. The play resume information is information indicating whether playing the media information stopped by the play stop information resumes or not.

A process for playing media according to a plurality of link information such as link information will be explained below.

[Link information 1]
<a href=“dict:discover” starttime=“35:24” duration=“1:50” out=“sound” sync=“on” icon=“book”>

Link information is information in a HTML anchor tag type. Here, the script instruction “dict:discover” of the link information 1 means “search the word discover with a predetermined dictionary”. the script instruction starttime=“35:24” means that a start time is 35 min. and 24 sec., and duration=“1:50” is that the duration is 1 min. and 50 sec. the script instruction out=“sound” means that the output type is sound. That is, the apparatus for playing media 110 verifies that the output type of link information is sound and thus outputs the searched dictionary meaning of the word, discover, with sound. Here, when the output type is included in the link information as out=“caption”, the apparatus for playing media 110 outputs the searched dictionary meaning of the word with text in a caption format.

The script instruction sync=“on” is play stop information to maintain (not to stop) playing media information included in the media file.

The script instruction icon=“book” means that the link is displayed with an icon of which identification information is “book”. Thus, the apparatus for playing media 110 can display the icon of a predetermined book shape of which identification information is “book” as default at a predetermined location of a screen on which the media information is outputted as shown in FIG. 5.

In addition, the link information may further include location information for the location where a link is to be displayed. For example, the link information may include low=“50” and col=“1000” indicating the location where a link is to be displayed as shown in Link information 2, in which low=“100” means that the location where a link is to be displayed is the 50^{th} row pixel and col=“1000” means that the location where a link is to be displayed is the 1000^{th} column pixel.

[Link information 2]
<a href=“dict:discover” starttime=“35:24” duration=“1:50” out=“sound” sync=“on” icon=“book” low=“100” col=“1000”>

Accordingly, the apparatus for playing media can display the icon of a predetermined book shape of which identification information is “book” as default at the location corresponding to the location information of a screen on which the media information is outputted as shown in FIG. 6.

Furthermore, the link information may represent a plurality of links as shown in Link information 3 below. The link information including a plurality of link information is called as group link information.

[Link information 3]
<a href=“video:linkgroup” starttime=“35:24” duration=“1:50” out=“display” sync=“on” icon=“menulist”>
<a href=“video:http://www.ucc.com/ucc1.mkv” out=“main” sync=“stop” back=“on”>UCC1</a>
<a href=“video:http://www.ucc.com/ucc2.mkv” out=“main” sync=“stop” back=“off”>UCC2</a>
<a href=“video:http://www.ucc.com/ucc3.mkv” out=“main” sync=“stop” back=“on”>UCC3</a>
</a>

The script instruction “video:linkgroup” is an instruction which indicates a link group including a plurality of links. A tag including the script instruction “video:linkgroup” (hereinafter, referred to as a group tag) may include a plurality of tags which indicate playing contents. The script instruction out=“display” means that “output each tag of the group tag in a list form on a screen”. The script instruction icon=“menulist” means that a link is displayed in an icon type of which identification information is “menulist”.

Therefore, the apparatus for playing media 110 outputs the icon of which identification information is “menulist” as the start time is arrived during the media file is displayed. In addition, when a user selects the outputted icon, the apparatus for playing media 110 displays the link of each tag of the group tag. The script instruction “video:http://www.ucc.com/ucc1.mkv” is a script instruction to play video contents corresponding to the address of “http://www.ucc.com/ucc1.mkv”. The script instruction “video:URL” is a script instruction to play video contents corresponding to URL. The script instruction out=“main” means to display contents on a main screen (in which the main screen is a predetermined screen), the script instruction sync=“stop” is play stop information to stop displaying the media information included in the media file when the contents is outputted. The script instruction back=“on” is play resume information indicating that playing the media information can be resumed after the contents is played and displayed, and back=“off” is play resume information indicating that playing the media information cannot be resumed after the contents is played and displayed.

Therefore, the apparatus for playing media 110 can display the link of each tag included in the group tag. When a user selects one of the links (for example, a link of UCC1), the apparatus for playing media 110 can receive video contents corresponding to the script instruction of the selected link. Here, the apparatus for playing media 110 can display video contents on a main screen as the output type is out=“main”. Here, the apparatus for playing media 110 can also stop playing the media information included in the media file with the script instruction sync=“stop”. During or after the contents is played, the apparatus for playing media 110 can resume playing the stopped media information with back=“on”. Here, the apparatus for playing media 110 can display a user interface such as icon which requests to resume playing the media information when the contents is played so that a user can request to resume playing the media information.

In addition, the output type of the link information can exhibit that the contents can be played in “picture in picture”.

[Link information 4]
<a href=“video:http://www.video.com/video.avi” starttime=“35:24” duration=“1:50” out=“pip” sync=“pause:auto resume” icon=“movie”>

For example, when the output type is set as out=“pip” as shown in the Link information 4, the apparatus for playing media 110 can play the contents of http://www.video.com/video.avi in “picture in picture” type as shown in FIG. 8. Here, sync=“pause:auto resume” means that playing the media information is stopped during the contents is played and playing the media information is resumed automatically when playing the contents is completed.

The link information described above is only explained for receiving video contents but it is not limited to the video contents.

[Link information 5]
<a href=“file:http://www.document.com/docu.doc” starttime=“35:24” duration=“1:50” out=“download:external” sync=“on” icon=“download”>

For example, the link information may include a script instruction “file:http://www.document.com/docu.doc” which indicates receiving a file as shown in Link information 5. Thus, the apparatus for playing media can download the file of “http://www.document.com/docu.doc” while media information is played. Here, out=“download:external” means that when an additional application to open a corresponding file is installed in the apparatus for playing media 110, the corresponding file is opened through the corresponding application.

The link information described above is only explained in the HTML anchor tag type but it is not limited thereto since the type of link information can vary with implementation methods. That is, link information can be in a predefined programming language type according to implementation methods.

The link information described above includes script instructions including addresses of contents, start times, duration times, output types, media stop information and icon identification information, etc., and the apparatus for playing media 110 can perform to display links, receive contents, output the received contents, stop playing media information which is played or maintain playing media information, and the like.

While it has been described with reference to particular embodiments, it is to be appreciated that various changes and modifications may be made by those skilled in the art without departing from the spirit and scope of the embodiment herein, as defined by the appended claims and their equivalents. As such, many embodiments other than that set forth above can be found in the appended claims. The scope of the present invention should be interpreted by the following claims and it should be interpreted that all spirits equivalent to the following claims fall with the scope of the present invention.

What is claimed is:

1. An apparatus for playing media comprising:
a communication interface receiving a medial file through a network by being connected with a media file providing apparatus;
a processor playing the media file according to a predetermined program; and
a memory storing the program,
wherein the program is a program to perform:
playing media information of the media file;
extracting link information from the media file;
displaying a link according to a start time and a duration time of the link information;
receiving a user input for selecting a link; and
receiving contents corresponding to the link selected by the user.

2. The apparatus for playing media of claim 1, wherein the start time is the time when the link starts to be displayed, and the duration time is the time during the link is displayed.

3. The apparatus for playing media of claim 1, wherein the step for displaying a link according to a start time and a duration time of the link information comprises displaying the link with an icon corresponding to icon identification information included in the link information.

4. The apparatus for playing media of claim 3, wherein the step for displaying a link according to a start time and a duration time of the link information comprises displaying the icon at the location corresponding to location information of the link information.

5. The apparatus for playing media of claim 1, wherein the program is a program further to perform outputting the contents according to output modes included in the link information.

6. The apparatus for playing media of claim 5, wherein the output mode is any one of sound, Picture in picture (PIP), main screen output, and download.

7. The apparatus for playing media of claim 5, wherein the program is a program further to perform stopping playing the media information according to play stop information of the link information.

8. The apparatus for playing media of claim 7, wherein the program is a program further to perform resuming playing the media information according to play resume information of the link information.

9. The apparatus for playing media of claim 1, wherein the program is a program further to perform displaying the link corresponding to a plurality of link information included in group link information when the link information is group link information and a user input for selecting an icon corresponding to the group link information is received.

10. The apparatus for playing media of claim 1, wherein the link information is located right after a header or a key frame of the media file.

11. A method for playing media when an apparatus for playing media plays a media file, the method comprising:
playing media information of the media file;
extracting link information from the media file;
displaying a link according to a start time and a duration time of the link information;
receiving a user input for selecting a link; and
receiving contents corresponding to the link selected by the user.

12. The method for playing media of claim 11, wherein the start time is the time when the link starts to be displayed, and the duration time is the time during the link is displayed.

13. The method for playing media of claim 11, wherein the step for displaying a link according to a start time and a duration time of the link information comprises displaying the link with an icon corresponding to icon identification information included in the link information.

14. The method for playing media of claim 13, wherein the step for displaying a link according to a start time and a duration time of the link information comprises displaying the icon at the location corresponding to location information of the link information.

15. The method for playing media of claim 11, further comprising outputting the contents according to output modes included in the link information.

16. The method for playing media of claim 15, wherein the output mode is any one chosen from sound, picture in picture (PIP), main screen output, and download.

17. The method for playing media of claim 16, further comprising stopping playing the media information according to play stop information of the link information.

18. The method for playing media of claim 17, further comprising resuming playing the media information according to play resume information of the link information.

19. The method for playing media of claim 11, further comprising displaying the link corresponding to a plurality of link information included in group link information when the link information is group link information and a user input for selecting an icon corresponding to the group link information is received.

20. The method for playing media of claim 11, wherein the link information is located right after a header or a key frame of the media file.
